(19) United States
(12) Patent Application Publication
(10) Pub. No.: US 2018/0276895 A1
(43) Pub. Date: Sep. 27, 2018

(54) PERSONALIZED AUGMENTED REALITY IN A CONTROLLED ENVIRONMENT

(71) Applicant: GLOBAL TEL*LINK CORPORATION, Reston, VA (US)

(72) Inventor: Stephen L. HODGE, Aubry, TX (US)

(21) Appl. No.: 15/470,031

(22) Filed: Mar. 27, 2017

(51) Int. Cl. G06T 19/00; G09G 5/00

(52) U.S. Cl. CPC G06T 19/006; G09G 5/003

(57) ABSTRACT

A system and method for initiating a personalized augmented reality session via a augmented reality communication system in a controlled environment is disclosed. The system includes a profile subsystem configured to store an inmate profile of the inmate of the controlled environment. The system also includes a augmented reality subsystem that is configured to receive, from an augmented reality device, data related to a physical environment and retrieves the inmate profile from the profile subsystem. The augmented reality subsystem is further configured to generate an augmented reality element and providing the augmented reality element to the augmented reality device to be displayed within the augmented reality session.

### BACKGROUND

### Field

This disclosure relates to a system and method for providing a personalized augmented reality experience within a controlled environment.

### Background

In a controlled environment, such as a correctional facility, inmates have limited opportunities to entertain themselves or engage with others. Inmates may have certain opportunities to have communications with loved ones or browse websites or interact with certain content using a mobile device, but these opportunities are limited to the inmate's room or cell and/or designated rooms within the controlled environment. In other words, an inmate's experiences are limited to physical communications when conducting conventional communications or engaging in activities in a controlled environment.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of an exemplary augmented reality communication system, according to embodiments of the present disclosure.

FIG. 2 illustrates a block diagram of an exemplary communication center of the augmented reality communication system of FIG. 1, according to embodiments of the present disclosure.

FIG. 3 illustrates a block diagram of an exemplary augmented reality communication device of the augmented reality communication system of FIG. 1, according to embodiments of the present disclosure.

FIGS. 4A-4C illustrate an exemplary interface for displaying and interacting with multiple multimedia augmented reality elements within a controlled environment via the augmented reality communication system of FIG. 1, according to embodiments of the present disclosure.

FIG. 4D illustrates an exemplary interface for displaying and annotating augmented reality elements within a controlled environment via the augmented reality communication system of FIG. 1, according to embodiments of the present disclosure.

FIG. 4E illustrates an exemplary interface for viewing augmented reality elements within a controlled environment based on an interaction with a real-world element via the augmented reality communication system of FIG. 1, according to embodiments of the present disclosure.

FIG. 5A illustrates an exemplary interface for displaying an augmented reality input interface via the augmented reality communication of FIG. 1, according to embodiments of the present disclosure.

FIG. 5B illustrates an exemplary interface for displaying an augmented reality input interface and annotation screen via the augmented reality communication of FIG. 1, according to embodiments of the present disclosure.

FIG. 5C illustrates an exemplary interface for displaying an augmented reality input interface for a media application via the augmented reality communication of FIG. 1, according to embodiments of the present disclosure.

FIG. 5D illustrates an exemplary interface for viewing an augmented reality input interface for a media application via another output device in the augmented reality communication of FIG. 1, according to embodiments of the present disclosure.

FIG. 6 illustrates a flowchart diagram of an exemplary method of registering a user via the augmented reality system of FIG. 1, according to embodiments of the present disclosure.

FIG. 7 illustrates a flowchart diagram of an exemplary method of initiating an augmented reality session via the augmented reality system of FIG. 1, according to embodiments of the present disclosure.

FIG. 8 illustrates a flowchart diagram of an exemplary method of updating an augmented reality session via the augmented reality system of FIG. 1, according to embodiments of the present disclosure.

FIG. 9 illustrates a flowchart diagram of an exemplary method of monitoring an augmented reality session via the augmented reality system of FIG. 1, according to embodiments of the present disclosure.

FIG. 10 illustrates a block diagram of a general purpose computer that may be used to perform various aspects of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Exemplary Augmented Reality Communication System

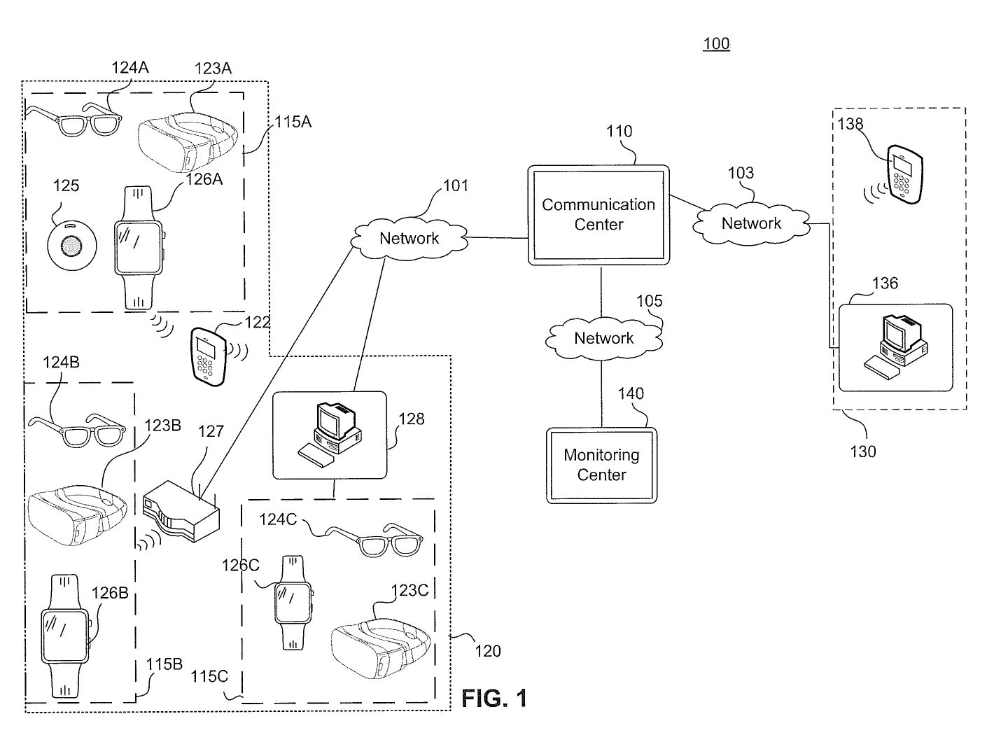

FIG. 1 illustrates a block diagram of augmented reality communication system 100, according to embodiments of the present disclosure. In some embodiments, augmented reality communication system 100 includes communication center 110 which is configured to receive and transmit augmented reality information within an augmented reality session to inmate communication system 120. An augmented reality session allows an inmate of a controlled environment to interact with physical objects in his physical environment and view content and applications while remaining aware of his physical environment. Accordingly, an augmented reality session concurrently displays the user's actual physical surroundings along with augmented reality information. Augmented reality information include but are not limited to multimedia content and real-world enhancements associated with the physical environment.

Multimedia content is considered augmented reality information when displayed within augmented reality elements such as a transparent overlay and viewed within augmented reality communication system 100. Real-world enhancements provide supplemental information regarding physical objects or content currently being viewed by the user through augmented reality devices 115A-115C. Such enhancements can include but are not limited to graphical overlays and visual annotations that supplement what the user is currently viewing through a display of augmented reality devices 115A-115C. Because augmented reality information enhances (and does not replace) physical objects or content, an inmate is partially (rather than fully) immersed within the augmented reality session while still deriving the benefits of a virtual space. An augmented reality session within augmented reality communication system 100 therefore differs from a virtual reality session which fully immerses the inmate within a virtual world that completely replaces the inmate's physical environment.

In some embodiments, the augmented reality session can also involve outsider communication system 130 if an outsider is authorized and registered and otherwise allowed to communicate with the inmate associated with inmate communication system 120. In some embodiments, an augmented reality session includes an augmented reality communication between an inmate and a device external to the controlled environment such as an outsider. An augmented reality communication can include real-time communications such as voice calls and video calls, non-real time communications such as a text or email, between an inmate using inmate communication system 120, communication center 110, and an outsider using outsider communication system 130, content (e.g., video, music, educational programs, games) communications between inmate communication system 120 and communication center 110.

In an embodiment, inmate communication system 120 includes one or more devices, such as augmented reality devices 115A-115C, provided to inmates within a controlled environment, such as a correctional facility. Inmate communication system 120 further includes devices such as wireless communication device 122, wireless access point 127 (e.g., gateway or router), and/or computer station 128. In some embodiments, augmented reality device 115A includes one or more of augmented reality headset 123A, augmented reality glasses 124A, augmented reality contact lenses 125, and/or augmented reality wearable 126A. In some embodiments, augmented reality device 115B includes one or more of augmented reality headset 123B, augmented reality glasses 124B, and/or augmented reality wearable 126B. In some embodiments, augmented reality device 115C may include augmented reality headset 123C, augmented reality glasses 124C, and/or augmented reality wearable 126C.

In some embodiments, augmented reality headsets 123A-123C have wired and/or wireless communication capabilities and augmented reality glasses 124A-124C, augmented reality contact lenses 125, and augmented reality wearables 126-126B have wireless communication capabilities. In an embodiment, augmented reality device 115A (e.g., augmented reality headset 123A, augmented reality glasses 124A, augmented reality contact lenses 125, and/or augmented reality wearable 126A) communicates with network 101 through a connection with wireless communication device 122. The communication with wireless communication device 122 may be a wireless connection, such as Bluetooth™ or Wi-Fi connections, or through a wired connection such as with a USB cable.

In an embodiment, augmented reality device 115B (e.g., augmented reality headset 123B, augmented reality glasses 124B, and/or augmented reality wearable 126B) communicates with network 101 through a connection with wireless access point 127. The communication with wireless access point 127 may be a wireless connection, such as Bluetooth™ or Wi-Fi connections or through a wired connection such as with a USB cable.

In an embodiment, augmented reality device 115C (e.g., augmented reality headset 123C, augmented reality glasses 124C, and/or augmented reality wearable 126C) communicate with network 101 through a connection with computer station 128. The communication with computer station 128 may be a wireless connection, such as Bluetooth™ or Wi-Fi connections or through a wired connection such as with a USB cable.

Inmate communication system 120 connects to communication center 110 via network 101, which may include any or all of a Local-Area Network (LAN), a Wide-Area Network (WAN), or the Internet, depending on the location of communication center 110 in relation to inmate communication system 120. For example, network 101 is implemented as a LAN when communication center 110 and inmate communication system 120 are both located at a controlled environment. In another example, network 101 is implemented as a WAN or the Internet when communication center 110 is located at a different location than inmate communication system 120.

Outsider communication system 130 includes one or more devices available to outsiders to the controlled environment and includes any and all devices such as computer station 136 and/or wireless communication device 138. Although not illustrated, outsider communication system 130 may include an augmented reality device however it is not necessary for outsider communication system 130 to include an augmented reality device in order for an outsider to communicate with inmate communication system 120. In an embodiment, outside communication system 130 may be located within the controlled environment, such as in a designated area or room of the controlled environment. In another embodiment, outside communication system 130 may be located outside of the controlled environment such as in the outsider's home. Outsider communication system 130 connects to communication center 110 via network 103, which may include any or all of a WAN, the Internet, and/or a Public Switched Telephone Network (PSTN). The WAN may facilitate communications with other nearby prisons, such as those within the same county, state, etc.

In an embodiment, WebRTC may be utilized in place of a session initiation protocol (SIP) over a WAN or the Internet, each of which provides a dedicated, private link between inmate communication system 120 and outsider communication system 130. The Internet is utilized to provide access to computer station 136 such as remotely distributed control stations, scheduling clients, and home visitation devices.

In an embodiment, augmented reality communication system 100 also includes monitoring center 140 for monitoring communications within augmented reality communication system 100 and to/from inmate communication system 120. Monitoring by monitoring center 140 can occur both automatically and manually (e.g., initiated a reviewer). Monitoring center 140 receives communications and data from communication center 110 via network 105, which may include any or all of a LAN, a WAN, or the Internet. In an embodiment, monitoring center 140 is further configured to communicate with communication center 110 to indicate approval of starting, sending, or receiving an augmented reality session. Monitoring center 140 receives information related to all augmented reality sessions that take place between devices in augmented reality communication system 100 through communication center 110. Monitoring center 140 can then utilize this information by recording the augmented reality session for later review and/or monitor the actions of users within the augmented reality communication system 100.

In an embodiment, recording of the augmented reality session entails recording one or more aspects of the augmented reality session. Aspects of the augmented reality session include but are not limited to an audio stream, a video stream, actions performed by the users during the augmented reality session, and content viewed by users during the augmented reality session. If users perform prohibited actions or interactions, monitoring center 140 may terminate the augmented reality session, provide a warning to the users, and/or provide an alert to the appropriate administrators. Monitoring center 140 can also provide a predetermined number of warnings to the users prior to terminating the augmented reality session. In another embodiment, monitoring center 140 is integrated into communication center 110.

In an embodiment, monitoring center 140 provides authorized content to communication center 110. The authorized content is available for use as part of any augmented reality sessions. For example, authorized content includes a list of websites that are available to be accessed by a user within an augmented reality session, a list of websites that are not available to be accessed, games, multimedia content, applications such as a word processing application, a text messaging application, a video conference application, and a multimedia application.

In an embodiment, content is authorized on a per user basis (i.e., applies only to a specific user or users based on, for example, the profile information) or on a global basis (i.e., applies to all augmented reality sessions through communication center 110). Monitoring center 140 can modify user profiles to include information that indicates the content for which the users are authorized and not authorized. For global restrictions, monitoring center 140 can send information that indicates the content that is authorized and not authorized for all users and all augmented reality sessions.

### Exemplary Communication Center

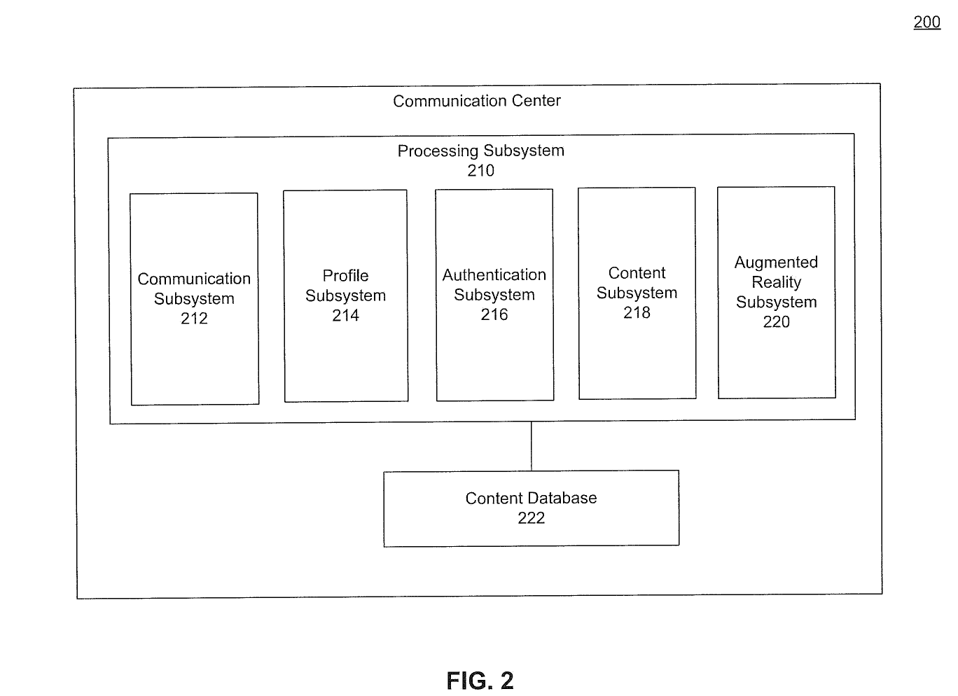

FIG. 2 illustrates a block diagram of communication center 200, according to embodiments of the present disclosure. In an embodiment, communication center 200 represents an exemplary embodiment of communication center 110 of FIG. 1. Communication center 200 includes but is not limited to processing subsystem 210 and content database 222. Processing subsystem 210 includes one or more processors, computers, or servers identified as subsystems and can be constructed as individual physical hardware devices, or as virtual devices, such as a virtual server. The number of processing subsystems can be scaled to match the number of simultaneous user connections desired to be supported by an augmented reality communication system such as augmented reality communication system 100 of FIG. 1. Processing subsystem 210 includes but is not limited to communication subsystem 212, profile subsystem, 214, authentication subsystem 216, content subsystem 218, and augmented reality subsystem 220.

In an embodiment, communication subsystem 212 controls the routing of communications to an end destination such as one or more devices within inmate communication system 120, one or more devices within outsider communication system 130, or monitoring center 140. Communication subsystem 212 performs switching required to electrically connect the one or more devices within inmate communication system 120 and one or more devices within outsider communication system 130 for an augmented reality session. Further, communication subsystem 212 logs communication information, including time of communications and parties involved in the communications, and store the logs and communications as files. The files stored by communication subsystem 212 can be stored indefinitely for use by monitoring center 140 in monitoring and investigation of an inmate and/or communication. Communication subsystem 212 also determines whether a communication should be monitored such that privileged communications such as attorney/client, doctor/client, or investigative communications are not monitored. Criteria for monitoring a communication may be based on jurisdictional requirements and/or identities of the parties.

In an embodiment, communication subsystem 212 is configured to receive contact information such as a phone number, email address, internet protocol address or other identifying data of the parties involved in an augmented reality session. The received contact information may be used by each of the subsystems of the communication center 200 for identifying respective data and processes related to the contact information, such as purported identities of parties involved in the communication.

Because there may be a variety of different communication standards employed by different audio, video, image, and text devices that wish to participate in an augmented reality session, in an embodiment, communication subsystem 212 is also configured to perform format conversion of non-real time communications. Conversion of incoming and outgoing communications are performed, as needed, to be compatible with inmate communication device 120, outsider communication device 130, or monitoring center 140. The conversion can convert incoming communications or outgoing communications to be compatible with inmate communication system 120 or the monitoring center 130. Further, because communication subsystem 212 receives and transmits communications by way of a network, in an exemplary embodiment, communication subsystem 212 is configured to decrypt received communications and encrypt transmitting communications, for security purposes.

Profile subsystem 214 obtains and stores profile information on parties registered to communicate via augmented reality communication system 100. In an embodiment, profile subsystem 214 stores inmate profiles and outsider profiles. Profile subsystem 214 obtains information related to the parties from one or more of (a) a jail management system (JMS) or an offender management system (OMS) operated by the jurisdiction of the correctional facility, (b) public database containing information on the parties, or (c) a questionnaire provided by a web page, a personal approved number (PAN) list, or booking information. Information obtained by profile subsystem 214 may include personal information such as previous residences or correctional facilities, authorized contacts, family members, languages, special needs, medication requirements, etc.

Profile subsystem 214 also performs a registration process for those parties not enrolled or registered to use augmented reality communication system 100. During the registration process, or at a later time, profile subsystem 214 determines accommodations and settings associated with a party and/or a party is able to select preferred settings for a communication. These accommodations and settings include, but are not limited to, preferences of the augmented reality session, such as favorite websites, purchased content, and/or preferences for applications. Profile information can also include a user's medical history which would be utilized in medical applications, a user's physical characteristics (e.g., dimensions of the user's forearm) which would be utilized in displaying certain augmented reality information, and physical characteristics of the user's room within the controlled environment (e.g., dimensions of the user's room, layout of the user's room).

In an embodiment, profile subsystem 214 also receives authorization information indicating content that is authorized and not authorized for each profile. The information may be received from a monitoring system such as monitoring center 140 as illustrated in FIG. 1. Profile subsystem 214 can store the authorization information internally or in content database 222. If the information is specific to a user or user(s), profile system 214 can also store the information as part of the user or user(s) profile(s). The authorization information is used to personalize the augmented reality session by limiting or allowing access to the content by users of the augmented reality session.

In an embodiment, authentication subsystem 216 collects and stores identity data of inmates and outsiders authorized to access augmented reality communication system 100. Identity data includes but is not limited to at least one of a username and password data, challenge questions, challenge answers, biometric data, device data such as make and model of a communication device, and/or location data. Biometric data includes one or more of a finger print, a hand print, a voice sample, an iris or retinal sample, an image of the user (2D or 3D), a hand geometry, a signature identification, an infrared camera identification, or any other biometric as deemed appropriate. The challenge question form of identity data may be a series of challenge questions, or a single challenge question such as the last four digits of an inmate's social security number, mother's maiden name, and the like. Authentication subsystem 216 is further configured to facilitate a secure communication between parties receiving/transmitting a communication by performing identity verifications to authenticate identities of purported parties. The identity verification includes logon verifications, such as username and password verifications, biometric verification, response to challenge questions, device verification, and/or location verification.

In an embodiment, authentication subsystem 216 continuously tracks biometric information during an on-going augmented reality session. For example, authentication subsystem 216 continuously tracks a user's eyes and provides the iris or retinal sample to a monitoring center through communication subsystem 212. In this manner, the monitoring center may monitor the augmented reality session to insure that an authenticated user does not hand off the augmented reality device to another user who has not been authenticated by authentication subsystem 216. Authentication subsystem 216 may also continuously monitor and provide voice data recorded during the augmented reality session to monitoring center 140 through communication subsystem 212.

Authentication subsystem 216 performs identity verification by receiving identity information such as one or more of a username and password, a response to a challenge question(s), a keypad or touch pad entry, dual tone multi frequency (DTMF) response, a voice sample, a fingerprint sample, a retinal sample, a facial image (2D or 3D), device information such as a make and model of the communication device, and/or a location of the communication device, from a communication device (such as a device of inmate communication system 120 or outsider communication system 130) and comparing the identity information of the purported party with stored identity data. Authentication subsystem 216 also uses the collected information to register users of augmented reality communication system 100. Once registered and entered into the system, users may log into augmented reality communication system 100 and initiate an augmented reality session.

Content subsystem 218 is responsible for retrieving and routing content to and from inmate communication system 120 such as augmented reality devices 115A-115C. Content subsystem 218 can be implemented as any number of servers, and is configured to facilitate the provision of content (e.g., games, applications, multimedia, emails, web) to inmate communication system 120. In some embodiments, content subsystem 218 retrieves content from a content source such as content database 222, which is located in communication center 200. In other embodiments, content database 222 may be located in monitoring center 140 or distributed between communication center 200 and monitoring center 140. All content that can be provided within augmented reality communication system 100 is pre-screened and authenticated by the controlled environment, such as through communication center 200. Content subsystem 218 is configured to receive requests identifying content to be provided to inmate communication system 120.

In an embodiment, augmented reality subsystem 220 consists of any number of servers, and functions as the primary logic processing center in communication center 200. Augmented reality subsystem 220 manages and facilitates augmented reality communications between subsystems of communication center 200 and devices external to the communication center, such as any device within inmate communication system 120 and outsider communication system 130. Augmented reality subsystem 220 provides augmented reality information to augmented reality devices 115A-C to enhance the content requested by the user. Augmented reality information can be stored in content database 222. In some embodiments, augmented reality information provides supplemental information regarding objects in an inmate's physical environment and graphical overlays for display in augmented reality devices 115A-115C by which an inmate may view and/or interact with multimedia content and communications. Augmented reality subsystem 220 determines which augmented reality information is appropriate for display on augmented reality devices 115A-115C to enhance content or physical objects being currently viewed by the user. Augmented reality information may be presented as a transparent graphical overlay over actual physical objects or within the physical environment currently being viewed by a user of augmented reality devices 115A-115C. As an example, augmented reality information may be presented within a transparent floating window in relation to the physical environment in which augmented reality devices 115A-115C are used.

Augmented reality subsystem 220 also includes software for performing real-time image recognition of video content provided by inmate communication system 120. As is discussed further below, augmented reality devices 115A-115C can include an outward facing camera for capturing a visual information representing the perspective of a user of augmented reality devices 115A-115C, which includes what the user is currently seeing (i.e., where the user's head is pointing) such as the physical environment of the user (e.g., a jail cell) or physical objects within the environment (e.g., a commissary catalog that the user is currently reading or objects within the jail cell). Augmented reality subsystem 220 performs real-time image recognition on the visual information to identify these objects or the physical location of the user. On the basis of this identification, augmented reality subsystem 220 can provided augmented reality information that enhances what the user is currently viewing.

After performing registration and authentication procedures as described above, augmented reality subsystem 220 initiates the augmented reality sessions for one or more augmented reality devices 115A-115C within augmented reality communication system 100. No matter the number of augmented reality devices, augmented reality subsystem 220 routes information regarding all augmented reality sessions to a monitoring center, such as monitoring center 140 in FIG. 1, through communication subsystem 212. Using this information, monitoring center 140 may monitor all aspects of augmented reality sessions, including the augmented reality information, the actions taken by the inmates, and content requested by the inmates.

In an embodiment, augmented reality subsystem 220 also enables passive surveillance capability by allowing for monitoring center 140 to join an ongoing augmented reality session to view in real-time what a user is viewing through any one of augmented reality devices 115A-115C. In this manner, monitoring center 140 can use cameras on augmented reality devices 115A-115C to monitor and view the current physical surroundings of all users of augmented reality system 100. Monitoring center 140 may join any or all ongoing augmented reality sessions. Accordingly, any and all visual information from any of augmented reality devices 115A-115C would be routed to monitoring center 140 through communication center 200.

In an embodiment, augmented reality subsystem 220 initiates augmented reality sessions based on the stored profiles of the user(s) involved in the augmented reality session. An inmate profile includes but is not limited the preferences of the inmate. In initiating an augmented reality session, augmented reality subsystem 220 retrieves the user profile for the user and personalizes the augmented reality session based on the preferences and information stored in the user profile. Personalizing the augmented reality session includes making available (or restricting the availability) within the augmented reality session preferred content and applications such as games. Personalizing may further include retrieving augmented reality information related to the user that would aid in the display of the augmented reality information during the augmented reality session such as retrieving a user's medical history, a user's physical characteristics, or the physical characteristics of the user's room within the controlled environment.

For example, a user's medical history can be utilized when the user starts a medical application to allow a doctor, who may be located at a remote location, to examine the user's body to perform a limited diagnosis or assist the user with certain medical actions, such as injection of medicine using a needless jet syringe applicator associated with the medical application. The user's and the room's physical characteristics can be utilized to customize how the augmented reality information is presented to the user on augmented reality devices 115A-115C.

If the augmented reality session involves two or more users, augmented reality subsystem 220 retrieves the user profiles for each of the users and personalizes the augmented reality session based on the preferences and information stored in the user profiles. If there are any conflicts in preferences, augmented reality subsystem 220 can prioritize certain user profiles and implement the preferences of user profiles that are prioritized higher than others.

In an embodiment, personalizing the augmented reality session also includes incorporating administrator preferences provided by an administrator of augmented reality communication system 100, such as a designated employee of the controlled environment. Administrator preferences are rules or restrictions provided by the administrator and have higher priority than the preferences specified in the user profiles. In an embodiment, administrator preferences include global preferences that influence all augmented reality sessions, no matter the users involved in the augmented reality session and inmate-specific preferences that only apply to specific inmates.

Administrator preferences generally limit or allow actions that can be performed by users during an augmented reality session. For example, the administrator can restrict all inmates and outsiders from accessing websites deemed to be inappropriate or certain applications and/or specify specific websites or applications that may be accessed during an augmented reality session. Administrator preferences can also restrict the augmented reality information that can be presented to the user. As discussed above, an administrator can implement such restrictions on a global (all augmented reality sessions) or inmate-specific basis.

In an embodiment, augmented reality subsystem 220 controls content that is available to users within augmented reality sessions based on authorization information indicating authorized content and unauthorized content. The authorization information can be specific to a user or user(s) and/or applied globally to all augmented reality sessions. Authorization information can indicate that a user or user(s) are not allowed to access certain content, such as websites, games, and/or applications, while participating in the augmented reality session. For example, if a user's profile indicates that the user is not allowed to access augmented reality information, the user would be prevented from being presented that information during the augmented reality session.

Content database 222 consists of any number of databases and/or servers, and stores and organizes data in a relational database. Content database 222 runs a database management system, such as MYSQL™, to provide an example. Content database 222 includes approved content that can be provided to users of inmate communication system 120 as part of an augmented reality session and augmented reality information. Content database 222 also includes organized data such that respective identity data, authentication data, jurisdictional requirements and rules, and settings that are indexed and linked to allow access to data for each of the parties involved in a communication and data associated with each of the parties.

### Exemplary Augmented Reality Device

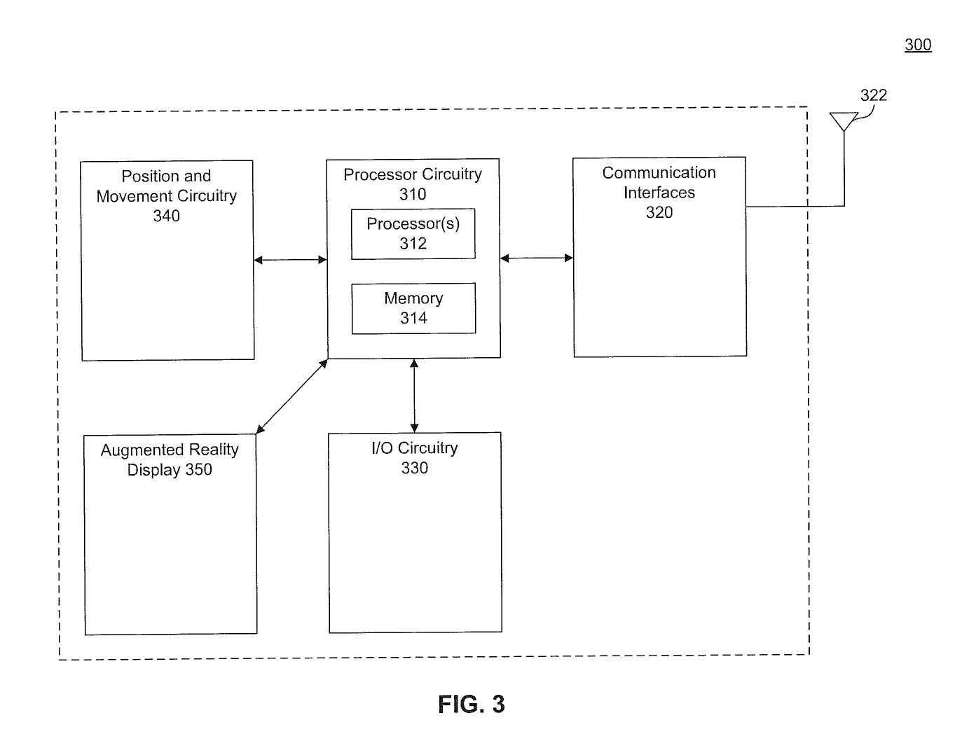

FIG. 3 illustrates a block diagram of augmented reality device 300, according to embodiments of the present disclosure. Augmented reality device 300 may be an exemplary embodiment of any of augmented reality devices 115A-115C as illustrated in FIG. 1. In an embodiment, augmented reality device 300 includes processor circuitry 310 that is communicatively coupled to plurality of communication interfaces 320, input/output circuitry 330, positional and motion circuitry 340, and augmented reality display 350. Processor circuitry 310 includes one or more processors 312, circuitry, and/or logic configured to control the overall operation of communication device 300, including the operation of communication interfaces 320, input/output circuitry 330, and positional and motion circuitry 340. Processor circuitry 310 further includes memory 314 to store data and instructions. Memory 314 may be any well-known volatile and/or non-volatile memory that is removable and/or non-removable.

Communication interfaces 320 include one or more transceivers, transmitters, and/or receivers that communicate via a wireless interface, such as through one or more antennas 322, or a wired interface, such as through a USB cable. In an embodiment, communication interfaces 320 are configured to transmit and receive communications between an inmate and an outsider via network 101 and network 103, as illustrated in FIG. 1. In an embodiment, communication interfaces 320 connect augmented reality communication device 300 with other devices such as a mobile device and/or external input devices such as a keyboard, mouse, camera, or touch interface.

In an embodiment, augmented reality communication device 300 includes integrated input/output circuitry 330 includes circuitry such as a microphone, an outward facing camera, and an inward facing camera. The outward facing camera is utilized for capturing visual information regarding the physical environment being viewed by a user of augmented reality communication device 300. Information from the outward facing camera is provided to communication center for processing by augmented reality subsystem 220. The inward facing camera is utilized to capture biometric information of the user of augmented reality communication device 300. Biometric information may be provided to authentication subsystem 216 for processing. Input/output circuitry 330 may be used by a party for traditional mobile device communications such as audio, video, or text communications. Input/output circuitry 330 such as the microphone and camera are used during monitoring operations to capture audio and/or video of a party and the surrounding physical environment.

In an embodiment, augmented reality device 300 includes positional and motion sensors 340 for determining a current location of communication device 300 as well as the current position and orientation of a user's head. Positional and motion circuitry 340 may include such circuitry as Global Positioning System (GPS) technology, indoor positioning systems (IPS) technology, accelerometers, and/or gyroscopes to determine position and motion of augmented reality device 300 and position and/or orientation of the user's head.

Input/output circuitry 330 and positional and motion sensors 340 can provide input to augmented reality device 300 through head, body, arm, eye and finger movements. Eye movement of a user of a augmented reality communication device 300 can be monitored through an inward facing camera. Eye movement of the user can operate much like a mouse by following the eye movement moving a cursor and utilizing the blinks of the eyes to select an item (i.e., similar to a mouse click). This allows for the entry of alpha numeric or the selection of items from the display without the user having to use his fingers or hands. Lunges and direction changes can be captured with accelerometers and gyroscope devices of positional and motion sensors 340. Input/output circuitry further includes a projector and other sensors for aligning the augmented reality information that is displayed as, for example, a graphical overlay, in relation to the physical real-world objects. Input/output circuitry 330 coordinates with processor 310 and/or communication center to adjust the display of the augmented reality information based on user's head movements and the new physical objects being viewed by input/output circuitry (e.g., an outward facing camera).

Augmented reality display 350 is a component for displaying augmented reality information as an overlay over physical objects that a user is currently looking at or within a physical environment of the user. In an embodiment, input/output circuitry 330 interacts with augmented reality display 350 to project the augmented reality information for viewing by the user. Augmented reality display 350 provides an unobstructed clear view of the user's current environment while also displaying the augmented reality information. As an example, the augmented reality information may be output by input/out circuitry 330 as a transparent graphical overlay through augmented reality display 350.

### Exemplary System Operation

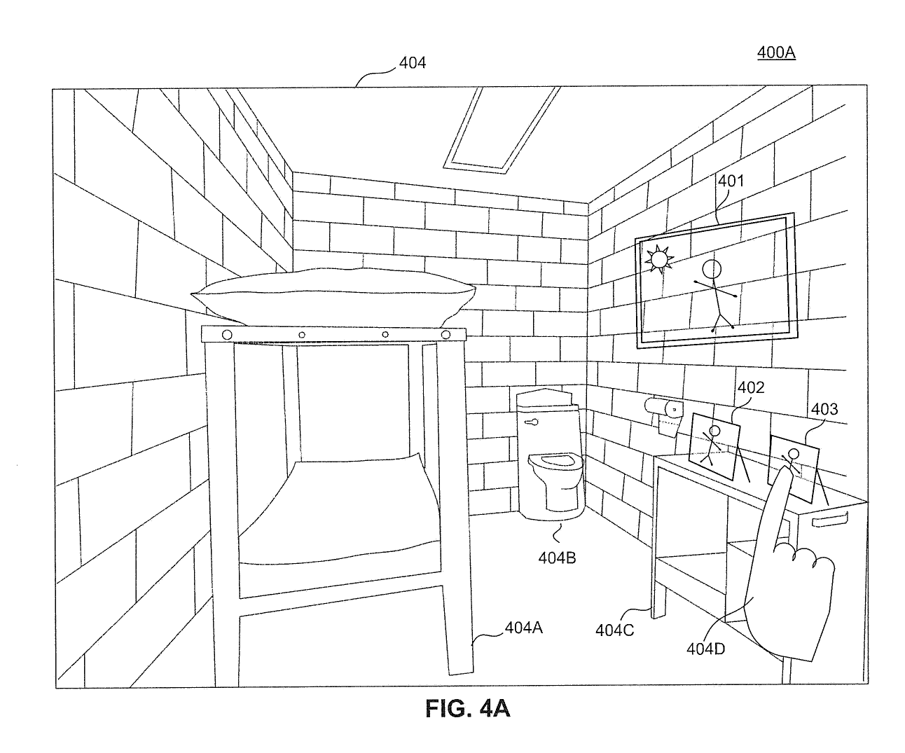

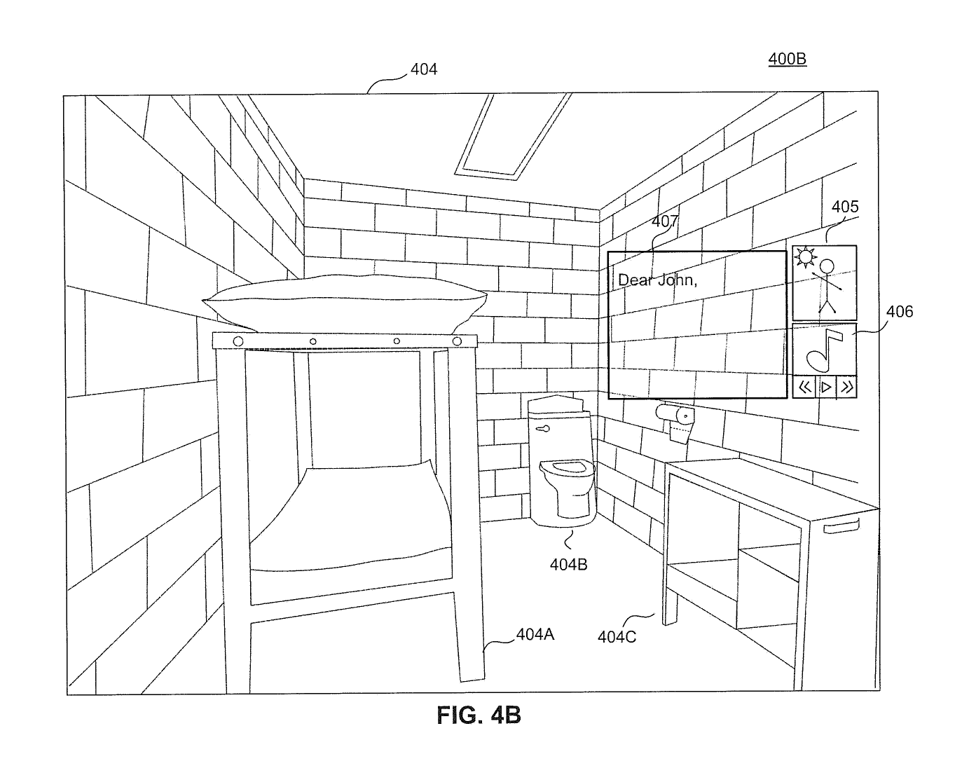

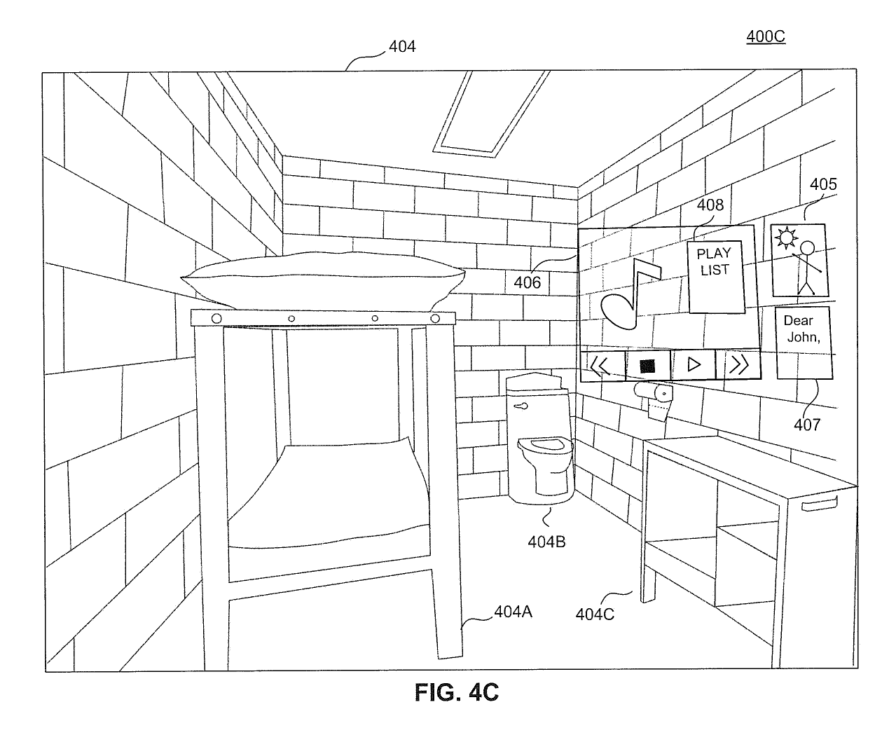

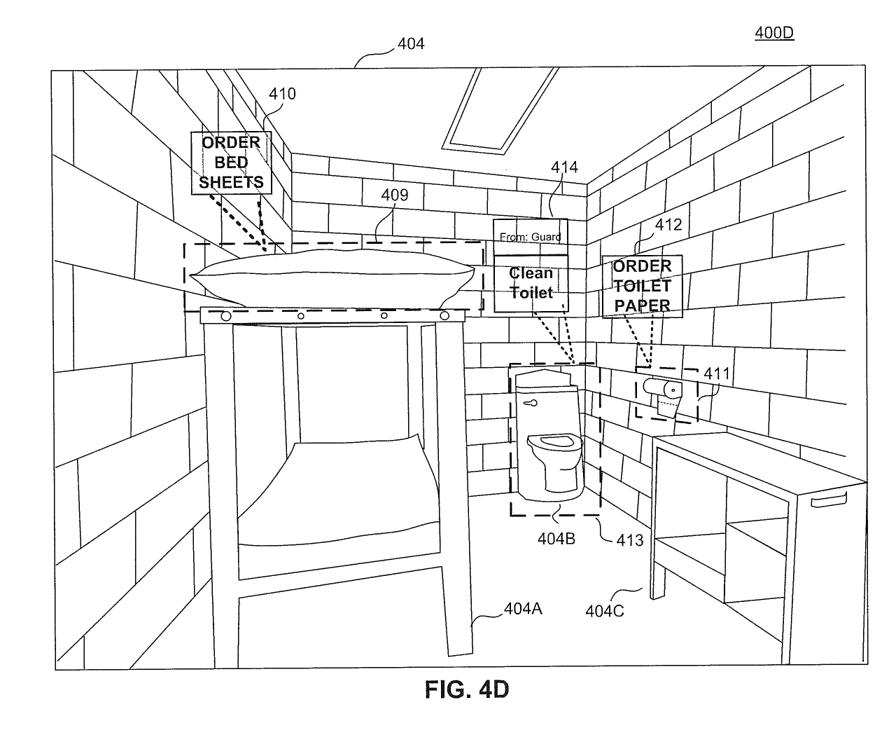

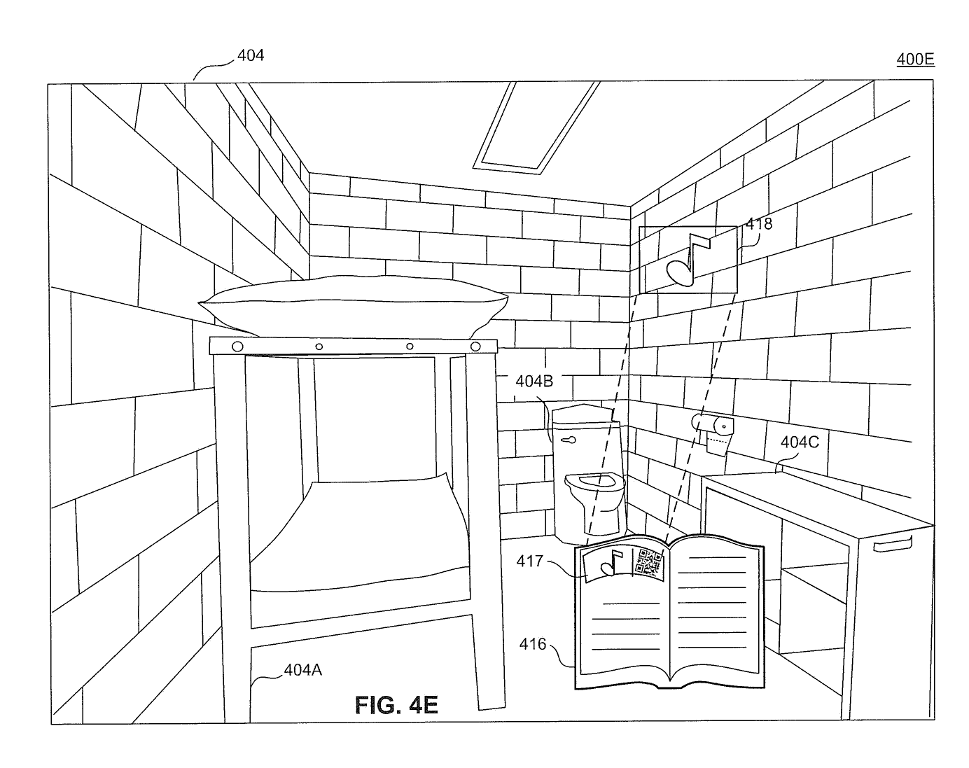

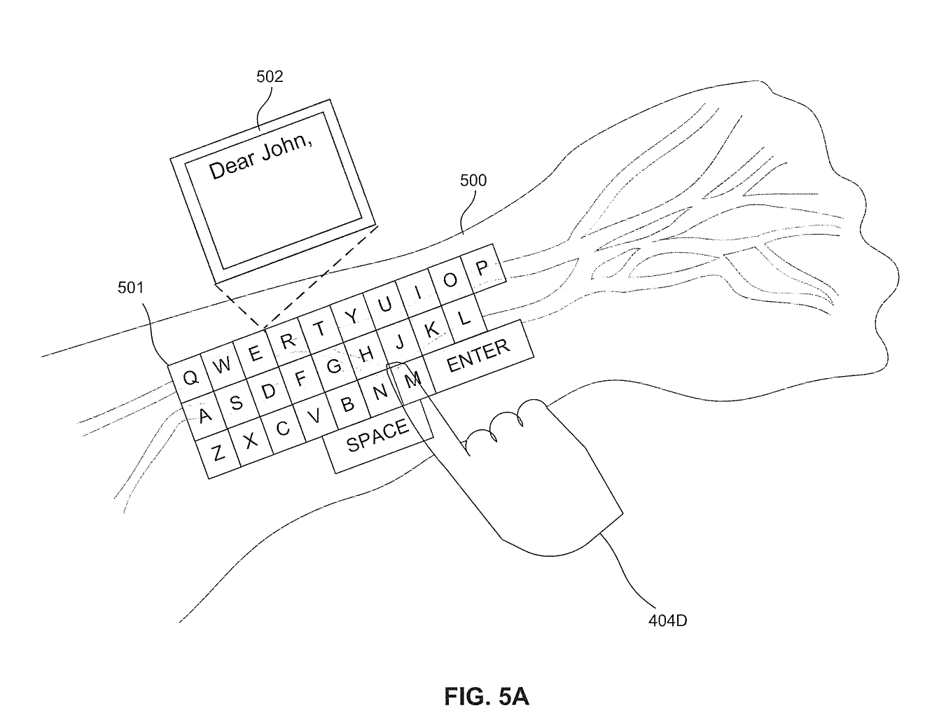

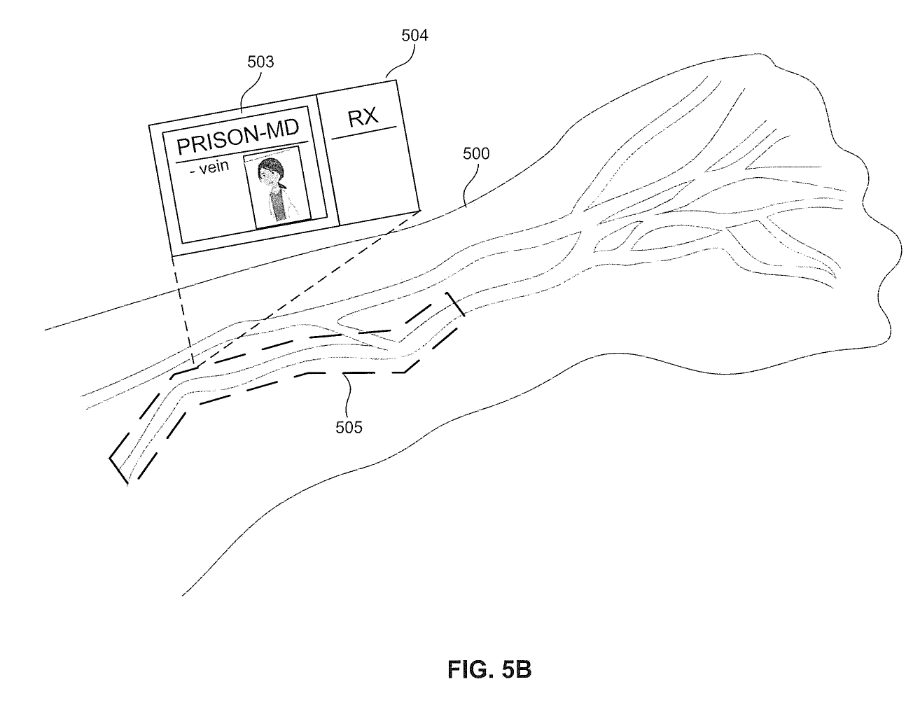

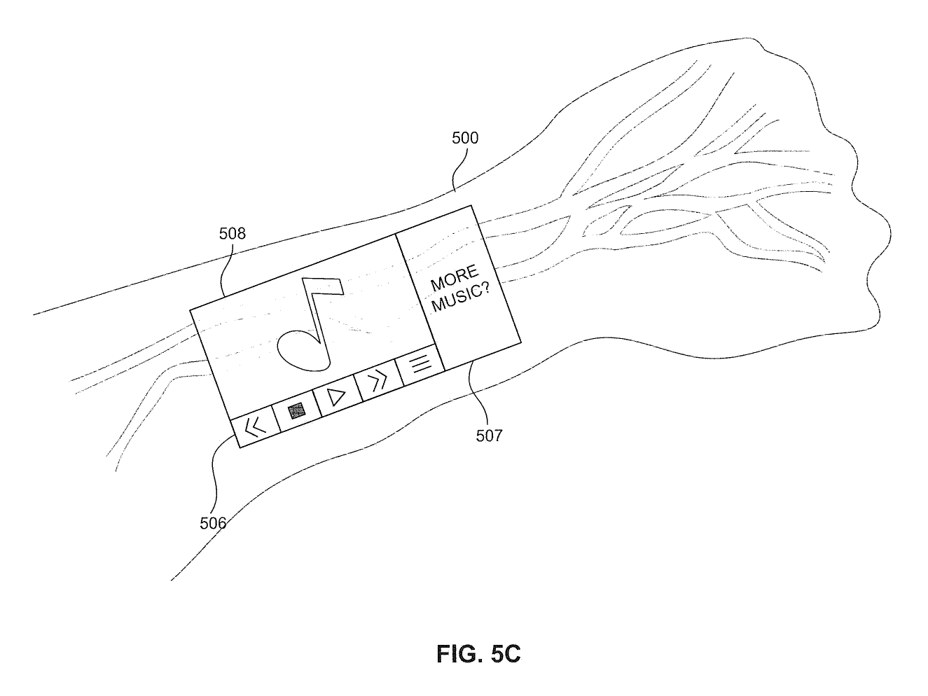

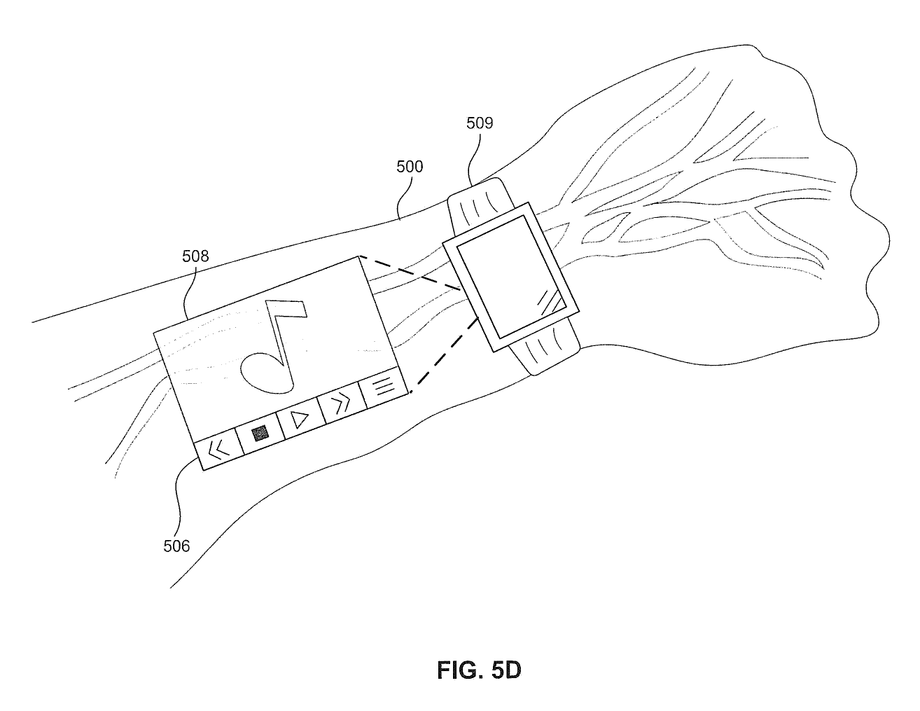

Exemplary usage of augmented reality communication system 100 in a controlled environment will be described with respect to FIGS. 4A-4E and FIGS. 5A-5C, according to some embodiments. The exemplary usage described in FIGS. 4A-4E and FIGS. 5A-5C can be performed by processing logic that can comprise hardware (e.g., circuitry, dedicated logic, programmable logic, microcode, etc.), software (e.g., instructions executing on a processing device), or a combination thereof. For illustrative purposes, FIGS. 4A-4E is described with respect to FIGS. 1-3 but are not limited to these example embodiments. For example, FIGS. 4A-4E is described with respect to augmented reality headset 123A but may apply to any of augmented reality devices 115A-115C. FIGS. 4A-4E and FIGS. 5A-5C include augmented reality elements which are graphical constructs viewable within augmented reality sessions and are configured to display augmented reality information. For example, if augmented reality information is content, augmented reality elements can be configured as multimedia content viewers for displaying the content. If augmented reality information are real-world enhancements, augmented reality elements can be configured as an information viewer for displaying the augmented reality information in relation to the physical object.

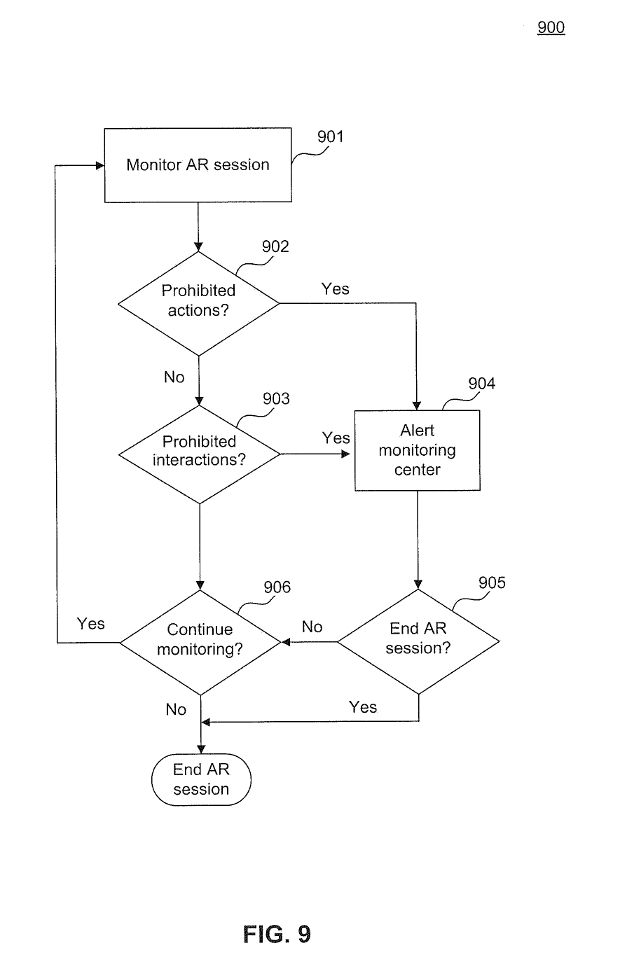

FIGS. 4A-4E also include augmented reality sessions which are simultaneously viewable through a display of augmented reality headset 123A and monitoring center 140. In other words, monitoring center 140 activate a passive surveillance feature and join any augmented reality session to view exactly what user of augmented reality headset 123A is viewing. Accordingly, monitoring center 140 may see what users are doing at all times while participating in augmented reality system 100 as well as ascertain the status of the user's physical environment. Passive surveillance thereby increases the monitoring capacity of monitoring center 140 to ensure the safety of the controlled environment. Moreover, all augmented reality sessions can be recorded and stored by monitoring center 140. Aspects of monitoring center 140 will be further discussed with respect to FIG. 9.

Also with regard to FIGS. 4A-4E and FIGS. 5A-5D, augmented reality subsystem 220 generates augmented reality sessions and augmented reality elements based on preferences stored in the user's profile. For example, augmented reality elements are selected based on the user's profile stored in profile subsystem 214. Prior to initiating an augmented reality session, the user may have preselected certain preferences, such as the types of augmented reality elements to be displayed as part of the user's augmented reality sessions. Communication center 220 receive these preferences and stores them in content database 222.

A user may select these preferences or otherwise interact with augmented reality session using a variety of input devices, including but not limited to the user's hand 404D. Other examples of input devices include but are not limited to a peripheral device controlled by the user (e.g., wand, a stylus, a pointer, a glove), the user's voice, and an augmented reality input interface (e.g., a virtual keyboard). For example, augmented reality system 220 performs gesture and voice recognition based on the type of input detected by augmented reality headset 123A.

In an embodiment, FIG. 4A depicts an exemplary embodiment of an augmented reality session 400A as viewed through augmented reality headset 123A. Augmented reality session 400A includes a visual display of the user's actual physical environment 404, such as a jail cell. In some embodiments, physical environment 404 includes actual physical objects 404A-404C, such as a bed 404A, toilet 404B, and/or a table 404C. Augmented reality session 400A also includes the user's actual hand 404D which can be used as an input interface to interact with augmented reality session 400A. In other words, augmented reality headset 123A includes a transparent graphical display which allows its user to view the user's actual surroundings.

Augmented reality session 400A further includes augmented reality elements 401-403 which are graphical overlays viewable concurrently with physical environment 404. Augmented reality elements 401-403 can be implemented as transparent graphical overlay such that they appear to be floating on top of actual physical objects within physical environment 404. For example, augmented reality element 401 can be implemented as a multimedia viewer that is displayed over a wall of physical environment 404. Augmented reality element 401 displays multimedia content selected by the user. Augmented reality subsystem 220 retrieves requested content from content database 222 and provides it for display at augmented reality headset 123A within augmented reality element 401. Examples of content that can be displayed within augmented reality element include but are not limited movies, music, games, and applications. For example, a user may select a certain video from a video library provided by the controlled environment and stored within content database 222.

Augmented reality elements 402 and 403 display images that the user has selected to be virtually displayed within augmented reality session 400A to virtually decorate physical environment 404. Augmented reality elements 402 and 403 can display static images or other types of static information which do not need to change over time. Augmented reality subsystem 220 can provide several options from which the user may select to be displayed within an augmented reality element.

Input/output circuitry 330 (e.g., an outward facing camera) of augmented reality headset 123A captures user's hand 404D as it travels through augmented reality session 404A and provides this captured information to augmented reality subsystem 220. Augmented reality subsystem 220 performs image and gesture recognition to identify user's hand 404D as an input device and a positional analysis of user's hand 404D to identify its position in relation to augmented reality elements 404A-C within augmented reality session 404A.

The positional analysis allows augmented reality subsystem 220 to, for example, determine that user's hand 404D is hovering over augmented element 403. User may then perform another action to indicate that the user wishes to select the augmented element 403. For example, the user can utilize a predetermined voice command that is recognized by input/output circuitry 330 (e.g., a microphone). Input/output circuitry 330 can send the recorded voice command for processing at augmented reality subsystem 220 which performs voice recognition on the voice command. If the recorded voice command corresponds to recognized command in relation to the position of user's hand 404D with respect to augmented reality element 403, augmented reality subsystem 220 allows the command to be performed.

For example, a user may say “select” while hovering his hand 404D over augmented reality element 403. Augmented reality subsystem 220 recognizes “select” as a command and recognizes that user's hand 404D is hovering over augmented reality element 403, and allows user to interact augmented reality element 403. Examples of interactions include but are not limited to selecting an augmented reality element, moving the element, and launching a new augmented reality element that displays options related to the selected augmented reality element. In this manner, the user may utilize his finger similar to a mouse within a desktop environment for selecting items within augmented reality session 404A. In other embodiments, gesture recognition may be performed by processor circuitry 310 of augmented reality headset 123A.

In an embodiment, FIGS. 4B-4C illustrate an example interface for displaying and interacting with augmented reality elements that display content within a controlled environment via the augmented reality communication system of FIG. 1, according to embodiments of the present disclosure. In an embodiment, FIG. 4B depicts an exemplary embodiment of an augmented reality session 400B as viewed through augmented reality headset 123A. Like augmented reality session 400A, augmented reality session 400B includes a visual display of the user's actual physical environment 404 and actual physical objects 404A-404C, such as a bed 404A, toilet 404B, and/or a table 404C. Augmented reality session 400B also includes augmented reality elements 405-407 which allow the user to multi-task.

For example, augmented reality element 407 can be implemented as a communication viewer that allows the user to receive and send text communications such as emails or text messages, augmented reality element 405 can be implemented as a picture viewer and augmented reality element 406 can be implemented as a multimedia player, where augmented reality element 406 displays information regarding the multimedia content currently being displayed and an interface to user to control augmented reality element 406. Although not displayed, user may interact with augmented reality element 406 using one of any input devices such as his hand (as discussed with respect to FIG. 4A) to select the controls displayed by augmented reality element 406. Examples of multimedia content include but are not limited to video conference applications, shopping applications, virtual education applications, communication applications, video games, movies, and music. For example, in a video conference application, any one of augmented reality devices 115A-115C may conduct a video conference with outsider communication system 130 and the video screen is displayed within an augmented reality element.

Augmented reality element 407 can be implemented as a larger window compared to augmented reality elements 405 and 406. The size of augmented reality elements 405-407 can be based on an indication as to which task the user is currently performing. For example, user is typing an email in augmented reality element 407 using an input device (as discussed above and as will be discussed with respect to FIG. 5A). Accordingly, augmented reality element 407 is displayed as larger window while augmented reality elements 405 and 406 are displayed as smaller windows.

FIG. 4C depicts augmented reality session 400C where the user is currently focusing on augmented reality element 406. Accordingly, augmented reality element 406 is displayed as a larger window compared to augmented reality elements 405 and 407, whose smaller dimensions relate to their decreased focus to the user. The larger window of augmented reality element 406 also allows additional information to be displayed such as augmented reality element 408. In some embodiments, augmented reality element 408 displays a list of multimedia content to be played by augmented reality element 406.

FIG. 4D illustrates an example interface for displaying and annotating augmented reality elements within a controlled environment via the augmented reality communication system of FIG. 1, according to embodiments of the present disclosure. In an embodiment, FIG. 4D depicts an exemplary embodiment of an augmented reality session 400D with augmented reality annotations as viewed through augmented reality headset 123A. Augmented reality annotations are examples of real-world enhancements viewable by the user. Augmented reality session 400D includes augmented reality elements 409-414. Augmented reality elements 409, 411, and 413 are transparent graphical overlays that surrounding real-life physical objects, such as a bed, toilet paper and a toilet. Although augmented reality elements 409, 411, and 413 are depicted as dotted lines, any other graphical elements are possible that highlight the physical objects.

Physical objects are identified through an image recognition process performed by augmented reality headset 123A and augmented reality subsystem 220. Input/output circuitry 330 of augmented reality headset 123A (e.g., an outward facing camera) records, as a video stream, physical objects currently being viewed by the user. The video stream is sent to augmented reality subsystem 220 which performs image recognition on the video stream to identify objects within the video stream. In another embodiment, image recognition is performed by processor circuitry 310 of augmented reality headset 123A.

Once identified, augmented reality subsystem 220 sends augmented reality information to be displayed by augmented reality headset 123A in relation to the physical objects. As discussed above, augmented reality information enhance and supplements physical objects or content that a user is currently viewing. For example, augmented reality element 410 displays augmented reality information with regard to the user's bed 404A and augmented reality element 409 (which highlights user's bed 404A). In other words, a physical object can trigger certain augmented reality information to be displayed. Examples of augmented reality information that enhance real-world objects include but are not limited to descriptions of the real-world object, annotations provided by a third-party, translations (e.g., if the real-world object is foreign language text), and shopping/advertising information (e.g., if the real-world object is a product that can be purchased by the user within the controlled environment). As one example, augmented reality element 410 can display to the user a link allowing the user to order new bed sheets (e.g., from a commissary of the controlled environment). Similarly, augmented reality element 411 surrounds toilet paper within physical environment 404 and augmented reality element 412 provides information allowing the user to order new toilet paper.

Augmented reality element 414 is configured to display an annotation regarding toilet 404B that is highlighted by augmented reality element 413. In some embodiments, an administrator may join augmented reality session 400D and view physical environment 404 from the perspective of the user. The administrator may send a message regarding a physical object, such as toilet 404B, to the user where the message is to be displayed within augmented reality element 414. For example, the administrator may notice that toilet 404B is dirty and needs to be cleaned. Accordingly, the administrator may utilize augmented reality element 414 as a way of annotating a real-world physical object within physical environment 404 and remotely informing the user to perform a certain task with regard to the physical object.

FIG. 4E illustrates an example interface for viewing augmented reality elements within a controlled environment based on an interaction with a real-world element via the augmented reality communication system of FIG. 1, according to embodiments of the present disclosure. Augmented reality session 400E includes a physical real-world object 416 that is currently being viewed by a user while wearing augmented reality headset 123A. Examples of physical real-world object 416 may include but are not limited to educational text books, catalogs for ordering products from within the controlled environment, and other physical media. Physical real-world object 416 may include an augmented reality trigger 417 that is recognized by input/output circuitry 330 of augmented reality headset 123A and/or augmented reality subsystem 220. Examples of augmented reality trigger 417 include but are not limited to barcodes, quick response (QR) codes, or any other predetermined images that can be scanned and recognized by input/output circuitry 330.

As an example, an outward-facing camera of augmented reality headset 123A captures a video stream of physical environment 404 which includes physical real-world object 416. The video stream includes augmented reality trigger 417 which includes a description of a music file and a QR code. The video stream can be processed by processor circuitry 310 of augmented reality headset 123A and/or sent to augmented reality subsystem 220 for remote processing. Regardless of where the video stream is processed, image recognition is performed which results in identifying augmented reality trigger 417 within the video stream. Augmented reality trigger 417 is related to certain augmented reality information in content database 222. Accordingly, upon recognition, augmented reality trigger 417 causes the related augmented reality information to be transmitted to and displayed by augmented reality headset 123A. In this example, augmented reality element 418 is generated and displayed which includes the display of the related augmented reality information (e.g., a music file).

While the augmented reality information of FIG. 4E is described as a music file, the disclosure is not limited to this embodiment. Other examples of augmented reality information that can supplement physical real-world object 416 include but is not limited to multimedia content (e.g., video) related to content in physical real-world object 416, advertisements, catalogs that display products that may be purchased, and real-time information (e.g., sports scores, weather, news, current events).

FIGS. 5A-5D illustrate displaying to display augmented reality elements based on recognizing a predetermined surface such as user's arm 500. Other examples of a predetermined surface include but is not limited to a table surface and a wall.

FIG. 5A illustrates an example interface for displaying an augmented reality input interface via the augmented reality communication of FIG. 1, according to embodiments of the present disclosure. Augmented reality headset 123A can also be configured to provide additional input devices such as augmented reality input interface 501 which can include a virtual keyboard that is displayed as if it were on a detected surface. In an embodiment, augmented reality headset 123A detects that the user is looking at his arm 500 based on image recognition techniques performed at augmented reality headset 123A or at augmented reality subsystem 220. Upon detecting arm 500, augmented reality headset 123A determines that the user would like an input device to interact with augmented reality element 502 and displays augmented reality input interface 501 which is displayed by augmented reality headset 123A. Augmented reality input interfaces are another type of augmented reality element and can be similarly implemented as a graphical overlay over a physical real-world object. In some embodiments, augmented reality element 502 is configured to display a communication that the user wishes to send such as an email.

Accordingly, augmented reality element 502 can concurrently display augmented reality input interface 501 on the user's detected arm as well as augmented reality element 502. In this manner, user of augmented reality headset 123A can utilize augmented reality input interface 501 to input text or otherwise interact with content displayed in augmented reality element 502. User may utilize another input device to interact with augmented reality input interface 501. As one example, user may use his hand 404D to point to specific points of augmented reality input interface to select letters to input into augmented reality element 502. Use of hand 404D was discussed with respect to FIG. 4A. Other means to interact with augmented input interface 501 include voice commands. For example, user may say “A.” Augmented reality headset 123A records the voice command and recognizes it as an input for augmented input interface 501. Augmented reality headset 123A may then select “A” and display it on augmented reality element 502.

FIG. 5B illustrates an example interface for displaying an augmented reality input interface and auxiliary screen via the augmented reality communication of FIG. 1, according to embodiments of the present disclosure. Augmented reality headset 123A can also be configured to perform image recognition and provide recognized images for use with augmented reality applications, such as a telemedicine application provided by the controlled environment. Augmented reality headset 123A recognizes user's arm 500 and a vein 505. This information is provided to communication center 200. If the user is currently engaged in a telemedicine application communicating with a doctor, information about the user's arm 500 and vein 505 can be provided to the doctor through telemedicine application.

In some embodiments, the doctor communicates with the user through augmented reality elements 503 and 504. For example, augmented reality element 503 is implemented as chat or information windows through which the doctor may enter instructions that can be read by the user. The doctor may identify to the user that vein 505 is a vein that can be used as an injection site for injecting medicine such as through a needless jet syringe applicator. Augmented reality element 504 is implemented as an auxiliary screen that is configured to display additional information such as the user's medical history (e.g., prior x-rays, ultrasounds), current prescriptions, and even advertisements approved by the controlled environment. While FIG. 5B is described with respect to user's arm 500, augmented reality headset can be configured to recognize any part of the user's body or object within the controlled environment such as a book as described with respect to FIG. 4E. Moreover, while FIG. 5B is described in relation to a telemedicine application, other applications include shopping applications, educational applications, and multimedia applications.

FIG. 5C illustrates an example interface for displaying an augmented reality input interface for a media application via the augmented reality communication of FIG. 1, according to embodiments of the present disclosure. Augmented reality headset 123A can be configured to display augmented reality elements 506-508 based on recognizing predetermined surface such as user's arm 500. In some embodiments, augmented reality element 508 is a multimedia player, augmented reality element 506 is an input interface for controlling augmented reality element 508, and augmented reality element 507 is an auxiliary screen that displays information related to content currently being displayed in augmented reality element 508.

FIG. 5D illustrates an example interface for viewing an augmented reality input interface for a media application via another output device in the augmented reality communication of FIG. 1, according to embodiments of the present disclosure. Augmented reality wearable 509 can be worn by user that coordinates with augmented reality headset 123A to provide an augmented reality session to the user. In some embodiments, augmented reality wearable 509 includes a projector for displaying augmented reality elements 508 and 506 on user's arm 500. Augmented reality wearable 509 can be configured to communicate a user's interactions with augmented reality elements 506 and 508 to augmented reality headset 123A. For example, if a user selects the “play” symbol of augmented reality element 506 (e.g., by pointing this finger on the symbol), augmented reality wearable 509 detects the selection and conveys the selection to augmented reality wearable 509, which processes the selection as a command for playing content in augmented reality element 508. In this manner, augmented reality wearable 509 and augmented reality headset 123A coordinate to provide the augmented reality experience to the user.

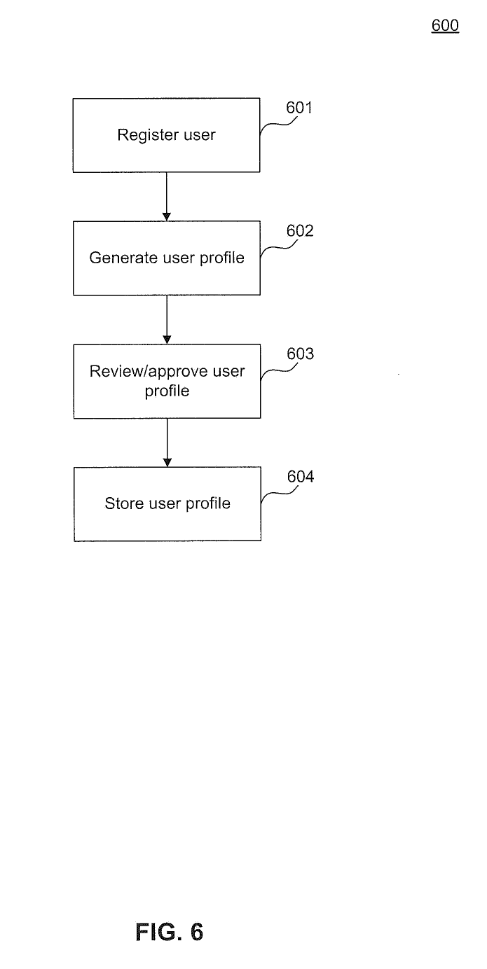

Operations of providing access, initiating and updating an augmented reality session, and monitoring the augmented reality session within augmented reality communication system 100 in a controlled environment will be described with respect to FIGS. 6-9. Although the physical devices and components that form the system have largely already been described, additional details regarding their more nuanced operation will be described below. While FIGS. 6-9 contain methods of operation of authentication for augmented reality communication system 100, the operations are not limited to the order described below, and various operations can be performed in a different order. Further, two or more operations of each method can be performed simultaneously with each other.

FIG. 6 illustrates a flowchart diagram of a method 600 of registering a user via an augmented reality communication system, such as augmented reality communication system 100 of FIG. 1, according to embodiments of the present disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

In FIG. 6, a registration or enrollment process is facilitated for a party by any one of augmented reality devices 115A-115C. In 601, a user registers prior to the first use of augmented reality communication system 100. Registration may be performed via a website or IVR system, for example, when the user visits a designated website or calls a designated phone number facilitated by the controlled environment. In 601, profile subsystem 214 (as described with respect to FIG. 2) requests initial information from the user via any one of augmented reality devices 115A-115C. The initial information can include the user's name, birthdate, social security number, contact information, biometric sample, and/or other essential data needed to verify the user and obtain additional information associated with the user, as described below. The initial information may be received by input/output circuitry 330 of augmented reality device 300 and transmitted to communication center 110 via communication interface 320.

At 602, once the initial information is received by communication center 110, profile subsystem 214 generates a user profile, such as an inmate profile, based on the initial information provided by the user. At 603, a component of the controlled environment, such as communication center 110 or monitoring center 140, reviews and approves or denies the generated profile to ensure that the profile meet predefined standards. After review of the initial information, the generated profile, and the generated avatar, communication center 110 and/or monitoring center 140 may accept the registration or reject the registration. At 604, all gathered and generated information obtained by communication center 110 is stored in a component of the controlled environment, such as in database 220.

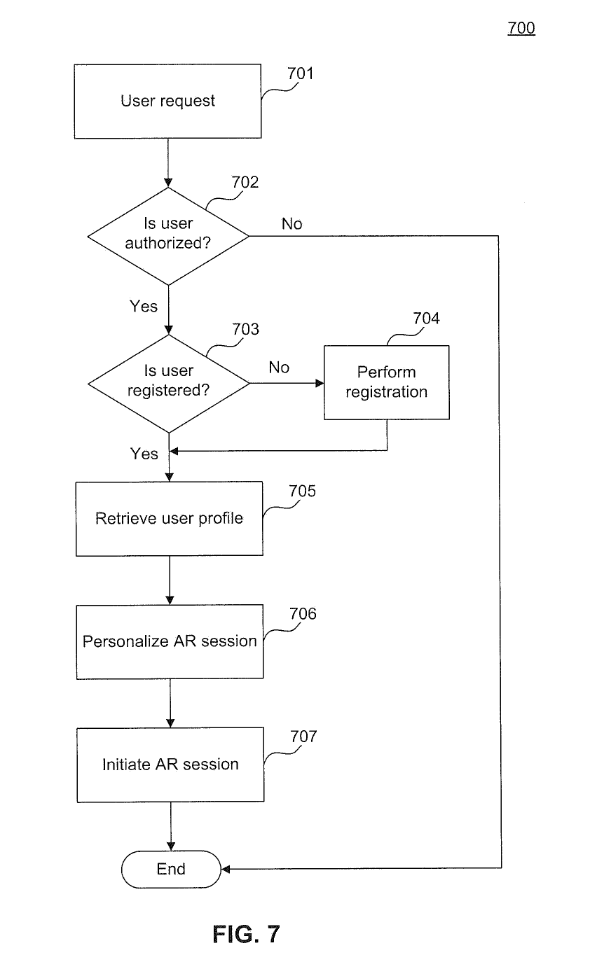

FIG. 7 illustrates a flowchart diagram of a method 700 for initiating an augmented reality session via an augmented reality communication system, such as augmented reality communication system 100 of FIG. 1, according to embodiments of the present disclosure. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

At 701, a user submits a request to communication center 110 to initiate an augmented reality session. The user request can be submitted any one of augmented reality devices 115A-115C under control of the user from a controlled environment. In an embodiment, submitting a user request requires special software installed on any one of augmented reality devices 115A-115C provided by the controlled environment and installed on the augmented reality devices. For example, an inmate opens the special software and presses an icon to submit a request for an augmented reality session. The functionality of the special software can be limited to only the inmate.

Next, at 702, communication center 110 determines whether the user submitting the request is authorized to initiate an augmented reality session. Communication center 110 can make this determination based on information included in the user request such as the identity of the user, the augmented reality device from which the request is submitted, or any other information identifying the user and/or the augmented reality communication device. In an embodiment, authorizing the user includes authenticating the user's identity. Examples of authentication that may be performed include one or more of challenge questions and biometric verifications. For example, a party may be required to answer a challenge question including responding to questions regarding one or more of a previous addresses of the party, the name of the party, a birthdate of the party, a PIN, a name of someone associated with the party, or an identification number of the party. Further, a challenge question may request only a portion of the actual answer, such as only the last four digits of the party's social security number be a response. Combination of authentication processes may also occur and may include a rolling challenge question that requires the party to audibly or visually respond to the challenge question. Examples of combinations of authentication may include a response to a challenge question that requires a party to verbally state his/her mother's maiden name or for the party to respond to the answer either verbally or by touch paid while in front of a camera of any one of augmented reality devices 115A-115C such that an audio sample, a video sample, or an image sample of the party is captured. In embodiment, authentication subsystem 216 receives the required information any one of augmented reality devices 115A-115C. The received information can be compared to stored identity data to determine whether the user is authorized. If the user is not authorized, the method ends. If the user is authorized, communication center 110 can further determine whether the user is registered to use augmented reality communication system 100 at 703. In an embodiment, communication center 110 can retrieve the relevant information to make this determination from profile subsystem 214. If the user is not registered, a registration or enrollment process is performed at 704. An exemplary registration process may include steps described above for FIG. 6.

Upon determining that the user is authorized an registered, communication center 110 can then retrieve the registered user's profile at 705. At 706, communication center 110 personalizes the augmented reality session based on the registered user and the retrieved profiles at 706. Personalizing the augmented reality session includes determining, from the retrieved profile, preferences and other information related to the augmented reality session. Each profile can include information regarding the user's preferences for content such as games and applications, as well as restrictions as to the content that is available or not available to the user and/or the augmented reality session. In 706, communication center 110 can further personalize the augmented reality session based on any administrator preferences. In an embodiment, this step entails retrieving the administrator preferences and implementing the rules and restrictions on the augmented reality session. As discussed above, administrator preferences may be applied on a global or in-mate specific basis. For example, administrator preferences may include global restrictions which limit all augmented reality sessions from accessing certain applications or content. Based on this information from the user profiles and the administrator preferences, communication center 110 generates and initiates the augmented reality session at 707, and begins the augmented reality session.

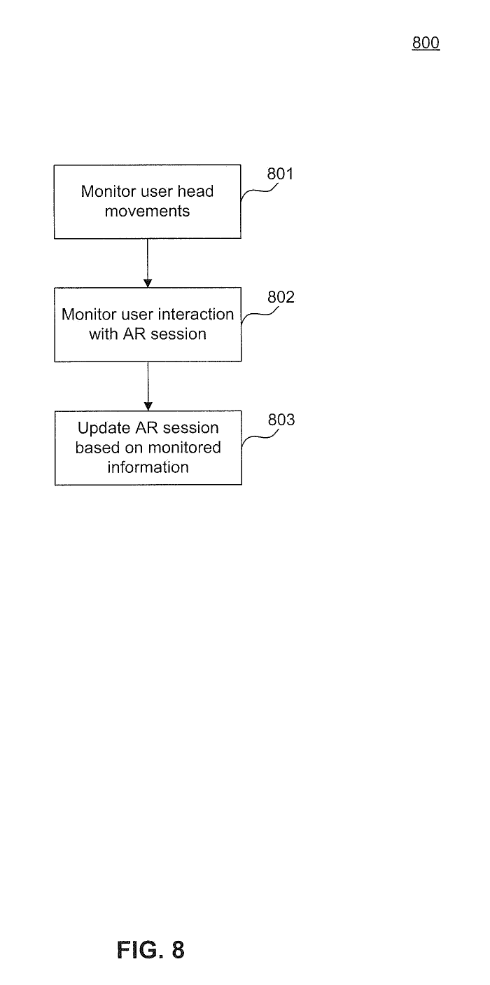

FIG. 8 illustrates a flowchart diagram of a method of updating an augmented reality session based on user movements via the augmented reality device of FIG. 3, according to embodiments of the present disclosure. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

At 801, during an initiated augmented reality session, augmented reality communication system 100 monitors the user's head movements based on the positioning of any of augmented reality device 300 on the user's head. In some embodiments, as discussed above, augmented reality device 300 comprise position and movement circuitry 340 that provide orientation and positioning information to communication center 110. The orientation and positioning information can be further provided to augmented reality subsystem 220 for analysis.

At 802, augmented reality communication system 100 monitors the user's interactions within augmented reality session through augmented reality device 300. Examples of interactions include but are not limited to selecting an augmented reality element and providing user inputs through I/O circuitry 330 of augmented reality device 300 such as voice comments and key inputs. The user's interactions can be further provided to augmented reality subsystem 220 for analysis.

At 803, augmented reality subsystem 220 utilizes the orientation and positioning information and the user's interactions to update the augmented reality session such that the augmented reality elements are correctly positioned and viewable by the user. For example, updating the augmented session includes re-orienting augmented reality elements, repositioning augmented reality elements, generating new augmented reality elements, and updating the augmented reality element based on the user's inputs.

FIG. 9 illustrates a flowchart diagram of a method 700 for monitoring a augmented reality session via a monitoring system, such as monitoring center 140 of FIG. 1, according to embodiments of the present disclosure. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art.

At 901, monitoring center 140 begins monitoring an augmented reality session initiated through an augmented reality communication system, such as augmented reality communication system 100 of FIG. 1. At 902, monitoring center 140 continuously monitors the on-going augmented reality session for any prohibited actions performed by a user of the augmented reality session. Prohibited actions can include any actions performed by a user that are determined by monitoring center 140 to be inappropriate for an augmented reality session. Monitoring can be done in real-time. For example, actions taken during the augmented reality session may be continuously compared to a predetermined list of prohibited actions autonomously by monitoring center 140 or may be monitored by an employee of monitoring center 140. Alternatively, monitoring can be performed after completion of the augmented reality session on a recorded augmented reality session. Prohibited actions may be specified by an administrator. Prohibited actions include but are not limited to violent actions, lewd actions, and attempting to access lewd or prohibited websites or content.

At 903, monitoring center 140 continuously monitors audio information of the augmented reality session for any prohibited verbal statements uttered by any user within the augmented reality session such as a session that involves more than one user. Prohibited verbal statements can include any comments stated by a user during the augmented reality session determined by monitoring center 140 to be inappropriate for a augmented reality session. For example, prohibited verbal statements can include curse words, lewd phrases, and/or sexual comments. Monitoring center 140 continuously monitors biometric information obtained from any user within the augmented reality session to prevent authorized users from giving the augmented reality device to a user that has not yet been authorized for the augmented reality session. As discussed above, in an embodiment, monitoring center 140 receives biometric information from communication center 110 which retrieves the biometric information from the augmented reality devices that are participating in the augmented reality session. Biometric information includes audio information, retinal or iris information, and facial information. During an augmented reality session, monitoring center 140 can compare current biometric information with original biometric information from the authorized user who initiated or joined the augmented reality session. If monitoring center 140 determines that there is difference between current biometric information and the original biometric information, monitoring center can determine that there has been a change in a user of augmented reality device 300.

If any of the steps of 902 or 903 are determined to be positive, a component of monitoring center 140 generates an alert to inform an administrator or other personnel of monitoring center 140 at 904. The alert can indicate that a prohibited action, prohibited verbal statement, or a change in the authorized user has taken place in the augmented reality session. At 905, monitoring center 140 determines whether the positive determines of steps 902 and 903 triggers a termination of the augmented reality session. Finally, at 906, monitoring center 140 determines whether to continue monitoring the augmented reality session. If so, monitoring center 140 repeats steps 901-904.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

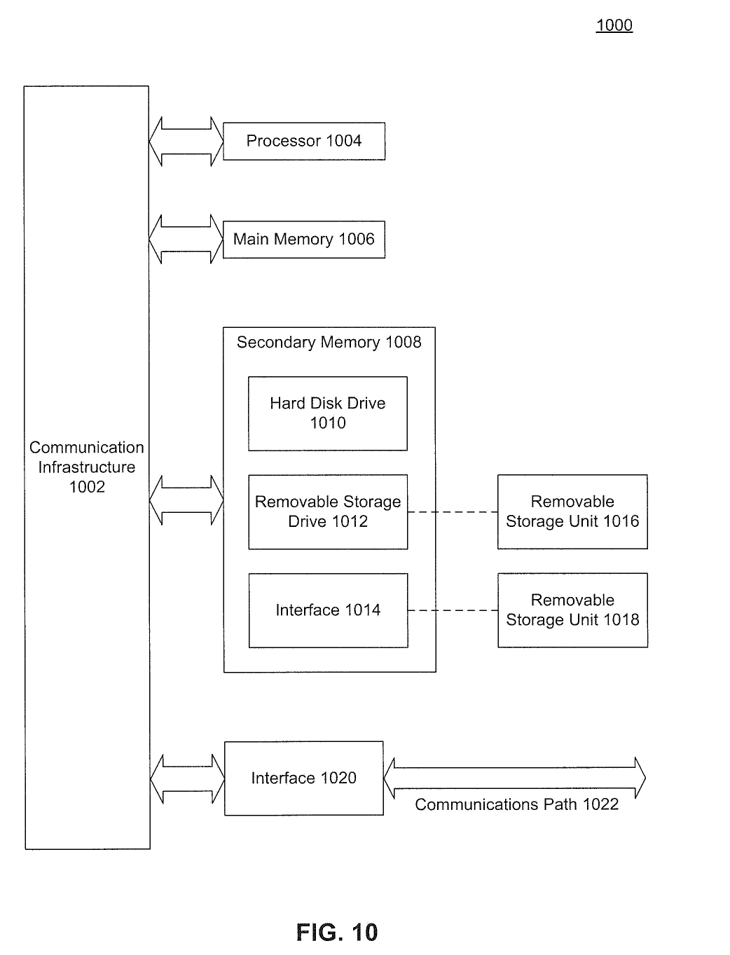

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the methods of FIGS. 6-9 can be implemented in the environment of one or more computer systems or other processing systems. An example of such a computer system 1000 is shown in FIG. 10. One or more of the modules depicted in the previous figures can be at least partially implemented on one or more distinct computer systems 1000.

Computer system 1000 includes one or more processors, such as processor 1004. Processor 1004 can be a special purpose or a general purpose digital signal processor. Processor 1004 is connected to a communication infrastructure 1002 (for example, a bus or network). Various software implementations are described in terms of this exemplary computer system. After reading this description, it will become apparent to a person skilled in the relevant art(s) how to implement the disclosure using other computer systems and/or computer architectures.

Computer system 800 also includes a main memory 1006, preferably random access memory (RAM), and may also include a secondary memory 1008. Secondary memory 1008 may include, for example, a hard disk drive 1010 and/or a removable storage drive 1012, representing a floppy disk drive, a magnetic tape drive, an optical disk drive, or the like. Removable storage drive 1012 reads from and/or writes to a removable storage unit 1016 in a well-known manner. Removable storage unit 1016 represents a floppy disk, magnetic tape, optical disk, or the like, which is read by and written to by removable storage drive 1012. As will be appreciated by persons skilled in the relevant art(s), removable storage unit 1016 includes a computer usable storage medium having stored therein computer software and/or data.

In alternative implementations, secondary memory 1008 may include other similar means for allowing computer programs or other instructions to be loaded into computer system 1000. Such means may include, for example, a removable storage unit 1018 and an interface 1014. Examples of such means may include a program cartridge and cartridge interface (such as that found in video game devices), a removable memory chip (such as an EPROM, or PROM) and associated socket, a thumb drive and USB port, and other removable storage units 1018 and interfaces 1014 which allow software and data to be transferred from removable storage unit 1018 to computer system 1000.

Computer system 1000 may also include a communications interface 1020. Communications interface 1020 allows software and data to be transferred between computer system 1000 and external devices. Examples of communications interface 1020 may include a modem, a network interface (such as an Ethernet card), a communications port, a PCMCIA slot and card, etc. Software and data transferred via communications interface 1020 are in the foul' of signals which may be electronic, electromagnetic, optical, or other signals capable of being received by communications interface 1020. These signals are provided to communications interface 1020 via a communications path 1022. Communications path 1022 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1016 and 1018 or a hard disk installed in hard disk drive 1010. These computer program products are means for providing software to computer system 1000.

Computer programs (also called computer control logic) are stored in main memory 1006 and/or secondary memory 1008. Computer programs may also be received via communications interface 1020. Such computer programs, when executed, enable the computer system 1000 to implement the present disclosure as discussed herein. In particular, the computer programs, when executed, enable processor 1004 to implement the processes of the present disclosure, such as any of the methods described herein. Accordingly, such computer programs represent controllers of the computer system 1000. Where the disclosure is implemented using software, the software may be stored in a computer program product and loaded into computer system 1000 using removable storage drive 1012, interface 1014, or communications interface 1020.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### Conclusion

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

What is claimed is:

1. A controlled environment augmented reality system, the system comprising:
a profile subsystem configured to store an inmate profile of an inmate;
an augmented reality subsystem having one or more processors and/or circuits configured to:
receive, from an augmented reality device, data related to a physical environment;
retrieve the inmate profile from the profile subsystem;
generate an augmented reality element based at least on the data related to the physical environment and the inmate profile, wherein the augmented reality element is configured to provide augmented reality information; and
transmit the augmented reality element to the augmented reality device, wherein the augmented reality element is further configured to be displayed during an augmented reality session involving the augmented reality device.

2. The system of claim 1, wherein the augmented reality information comprises at least one of multimedia content and enhancement information associated with the physical environment.

3. The system of claim 1, wherein the data related to a physical environment comprises at least one of a video stream of the physical environment and information about at least one physical object in the physical environment.

4. The system of claim 1, the augmented reality subsystem further configured to:
receive, from the augmented reality device, a user input associated with the augmented reality session.

5. The system of claim 1, further comprising:
a communication subsystem configured to receive session information regarding the augmented reality session, wherein the augmented reality subsystem is further configured to monitor the augmented reality session based on the session information.

6. The system of claim 5, wherein the communication subsystem is further configured to transmit the session information to a monitoring center.

7. The system of claim 1, wherein the augmented reality element is further configured to be display at least one of a multimedia content, an email, and an annotation related to a physical object in the physical environment.

8. The system of claim 1, wherein the augmented reality element is further configured to be displayed concurrently with the physical environment.

9. A method for conducting a controlled environment augmented reality session, the method comprising:
generating an augmented reality element based at least on data related to a physical environment and an inmate profile, wherein the augmented reality element is configured to provide augmented reality information;
transmitting the augmented reality element to an augmented reality device, wherein the augmented reality element is further configured to be displayed during an augmented reality session involving the augmented reality device;
receiving, from the augmented reality device, user input associated with the augmented reality session; and
transmitting the augmented reality information in response to receiving the user input.

10. The method of claim 9, further comprising:
retrieving the augmented reality information based on the user input and the inmate profile.

11. The method of claim 9, wherein the augmented reality information comprises at least one of multimedia content and enhancement information associated with the physical environment.

12. The method of claim 9, wherein the data related to a physical environment comprises at least one of a video stream of the physical environment and information about at least one physical object in the physical environment.

13. The method of claim 9, further comprising:
receiving session information regarding the augmented reality session; and
monitoring the augmented reality session based on the session information.

14. The method of claim 13, further comprising:
transmitting the session information to a monitoring center.

15. The method of claim 9, further comprising:
displaying at least one of a multimedia content, an email, and an annotation related to a physical object in the physical environment.

16. The method of claim 9, wherein the augmented reality element is further configured to be displayed concurrently with the physical environment.

17. The system of claim 16, wherein the augmented reality element is further configured to be displayed as a transparent window.

18. A non-transitory computer-readable medium having instructions stored therein, which when executed by a processor cause the processor to perform operations, the operations comprising:
receiving a user request from an augmented reality device;
determining whether a user associated with the user request is authorized to initiate an augmented reality session;
retrieving an inmate profile based at least on the user request and the determining whether the user is authorized to initiate an augmented reality session;
personalizing the augmented reality session based on the inmate profile; and
initiating the augmented reality session based on the personalizing the augmented reality session.

19. The non-transitory computer-readable medium of claim 18, wherein the personalizing the augmented reality session comprises retrieving augmented reality information related to the inmate profile.

20. The non-transitory computer-readable medium of claim 18, wherein the augmented reality information comprises at least one of a medical history, physical characteristics, or the physical characteristics of a controlled environment associated with the inmate profile.
